(19) United States
(12) Patent Application Publication
(10) Pub. No.: US 2013/0174394 A1
(43) Pub. Date: Jul. 11, 2013

(54) ENGAGE DEVICE FOR A TOOL SEAT OF A ROTARY TOOL TURRET

(71) Applicant: Chang Robin C.S., TAICHUNG CITY (TW)

(72) Inventor: Chang Robin C.S., TAICHUNG CITY (TW)

(73) Assignee: APEX DYNAMICS, INC., TAICHUNG CITY (TW)

(21) Appl. No.: 13/346,286

(22) Filed: Jan. 9, 2012

(51) Int. Cl. B23Q 16/00

(52) U.S. Cl. 29/39

(57) ABSTRACT

An engage device for a tool seat of a rotary tool turret includes an engage block mounted into the rotary tool turret for positioning the tool seat. A bolt extends through the engage block and is screwed into the rotary tool turret for holding the engage block in place and making the engage block securely abutting the tool seat. A locking member is mounted to the engage block to prevent the bolt from detaching from the engage block.

### BACKGROUND OF THE INVENTION

1. Field of the Invention The present invention relates to an engage device, and more particularly to an engage device for a tool seat that mounted to a rotary tool turret.

2. Description of Related Art

As well known, with reference to FIGS. 8 to 10, a rotary tool turret (10) includes multiple tool seats (11) mounted onto the rotary tool turret (10). The rotary tool turret (10) includes multiple first holes (12) and second holes (13) respectively defined therein, wherein each second hole (13) communicates with a corresponding one of the first holes (12) and a threaded hole (131) is centrally and longitudinally defined in a bottom of each of the second hole (13). Each tool seat (11) is partially received in a corresponding one of the first holes (12). The tool seat (11) is formed with an engage portion (111) facing the second hole (13). For positioning the tool seat (11), an engage block (14) is mounted into the second hole (13) for securely engaged to the tool seat (11) and holding the tool seat (11) in place. The engage block (14) has an engage portion (141) securely abutting against that of the tool seat (11). A sunken hole (142) is eccentrically defined in the engage block (14) and extends through the engage block (14). A bolt (15) rotatably extends through the sunken hole (142) and screwed into the threaded hole (131) to make the two engage portions (111, 141) securely abutting each other for securing the tool seat (11). A C-ring (143) is horizontally disposed in the sunken hole (142) to prevent the bolt (15) from detaching from the engage block (14) after being loosed for detaching the tool seat (11) from the rotary tool turret (10).

With reference to FIG. 9, when replacing the engage block (14), the bolt (15) is loosed and detached form the rotary tool turret (10). However, the engage block (14) is far away from an opening of the second hole (13) after the bolt (15) being completely loosed. Consequently, it is difficult to detach the engage block (14) with the bolt (15) from the rotary tool turret (10) even using an elongate tool because conventional engage block (14) has no structure to connected to any tool when drawing out the conventional engage block (14).

The present invention has arisen to mitigate and/or obviate the disadvantages of the conventional engage block for a tool seat of a rotary tool turret.

### SUMMARY OF THE INVENTION

The main objective of the present invention is to provide an improved engage block for a tool seat of a rotary tool turret, which can be easily detached from the rotary tool turret by an elongate tool.

To achieve the objective, the engage device in accordance with the present invention comprises an engage block mounted into the rotary tool turret for positioning the tool seat. A bolt extends through the engage block and is screwed into the rotary tool turret for holding the engage block in place and making the engage block securely abutting the tool seat. A locking member is mounted to the engage block to prevent the bolt from detaching from the engage block.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of and engage block for a tool seat of a rotary tool turret in accordance with the present invention;

FIG. 2 is an exploded perspective view of the engage block in FIG. 1;

FIG. 3 is a cross-sectional view of the engage block in FIG. 1;

FIG. 4 is a perspective schematic view of the engage block in accordance with the present invention;

FIG. 5 is a cross-sectional view for showing the engage block of the present invention when securely mounted into the rotary tool turret;

FIG. 6 is a first operational view of the engage block in accordance with the present invention;

FIG. 7 is a second operational view of the engage block in accordance with the present invention;

FIG. 8 is a schematic view of a conventional engage block for a tool seat of a rotary tool turret in accordance with the prior art;

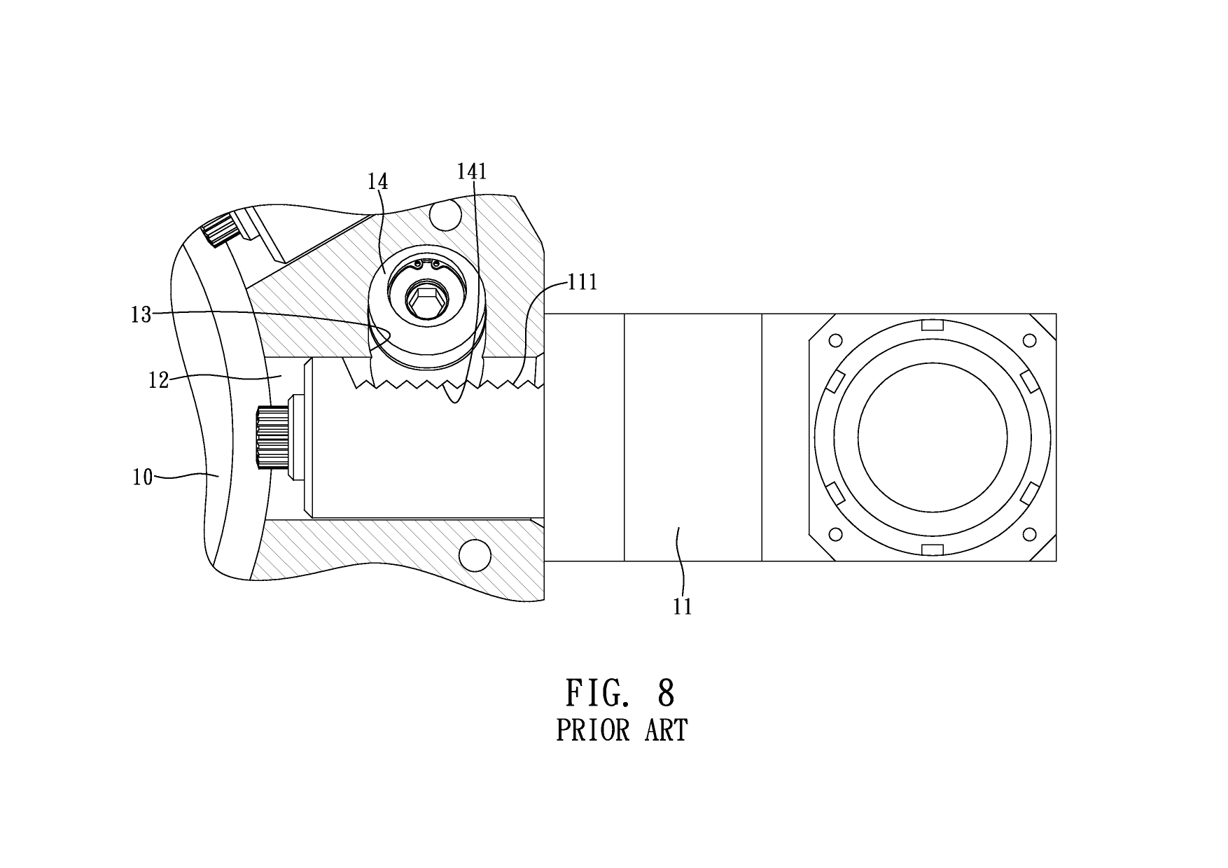

FIG. 9 is a cross-sectional schematic view of the conventional engage block in accordance with the prior art; and

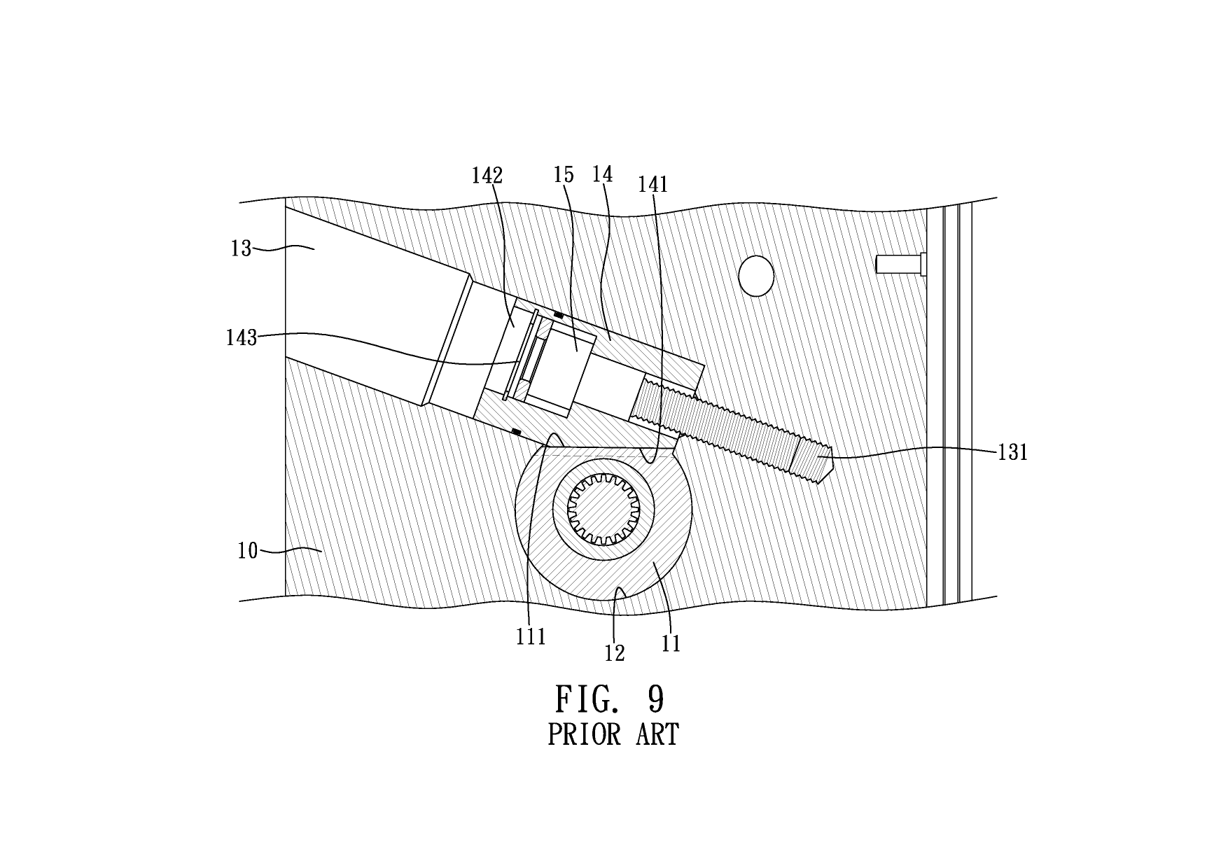

FIG. 10 is an operational view of the engage block in accordance with the prior art.

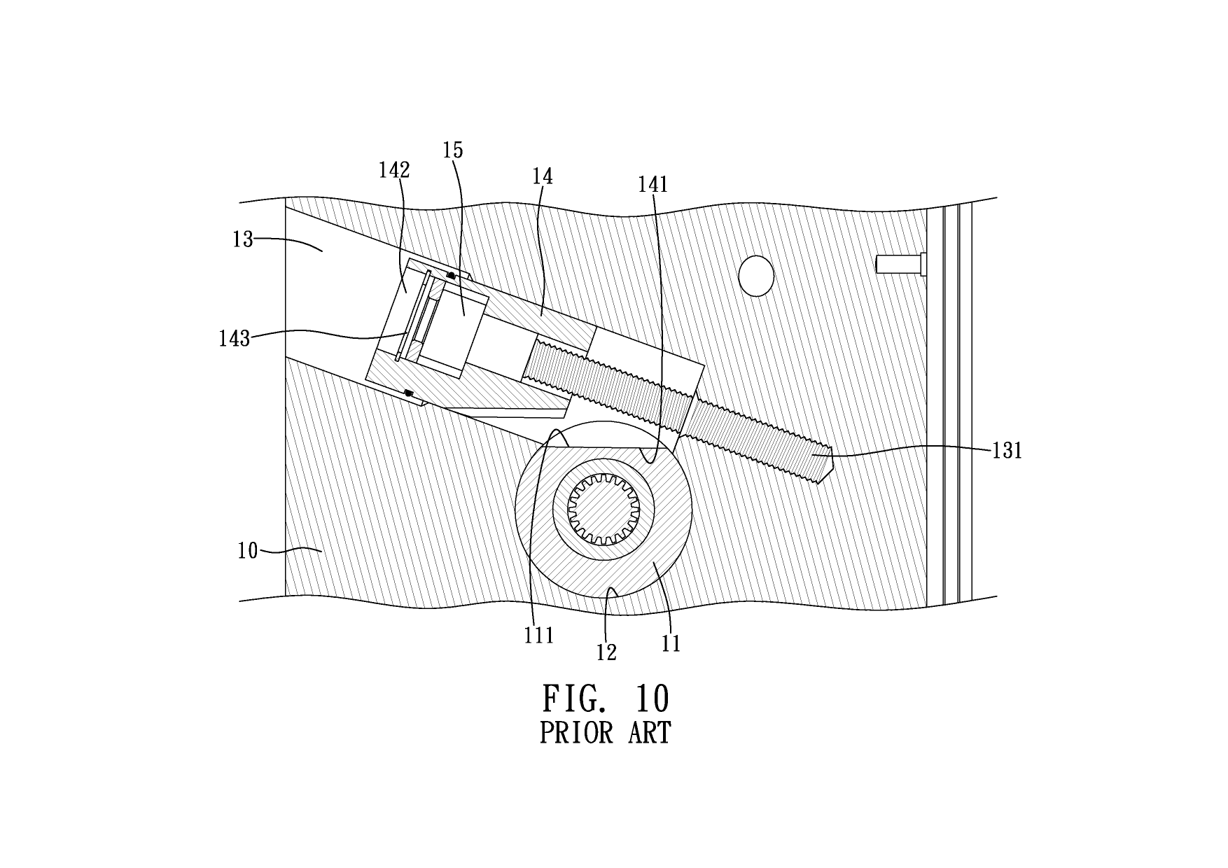

### DETAILED DESCRIPTION OF THE INVENTION

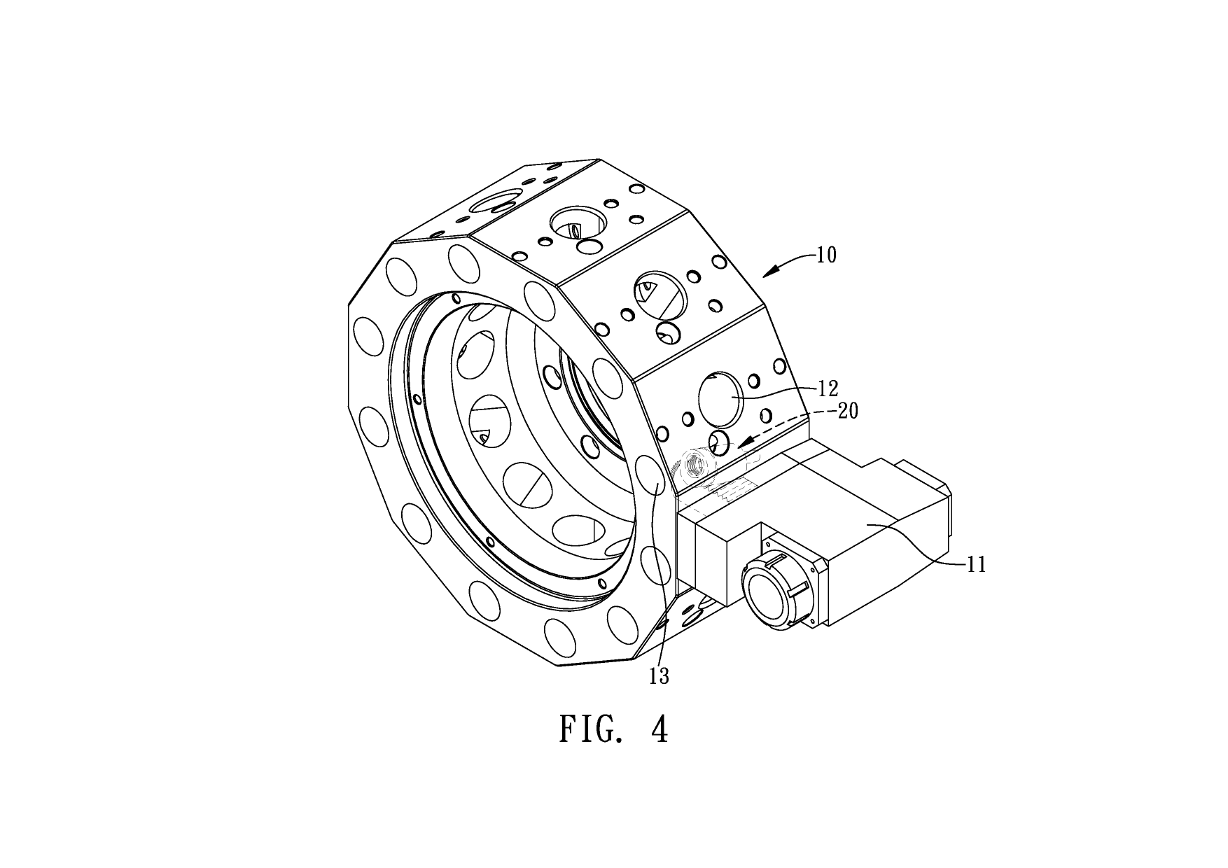

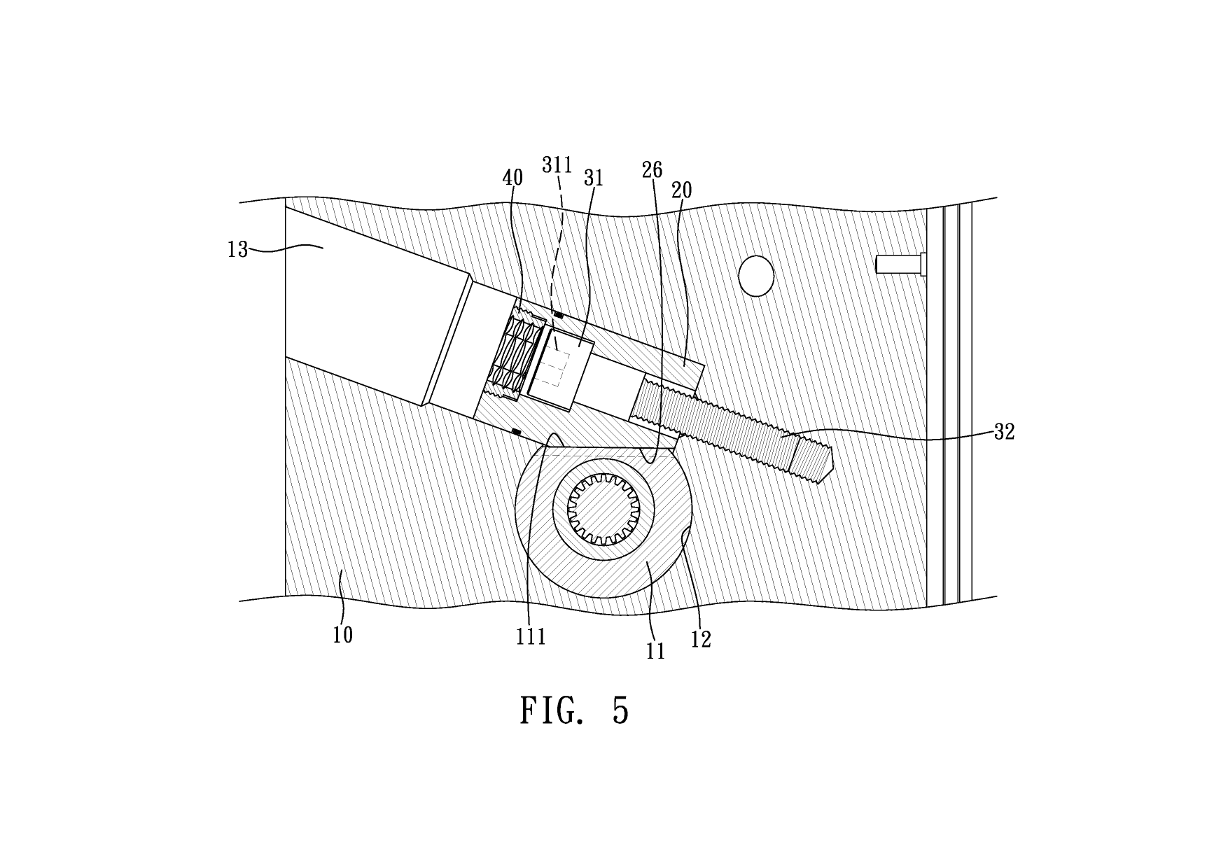

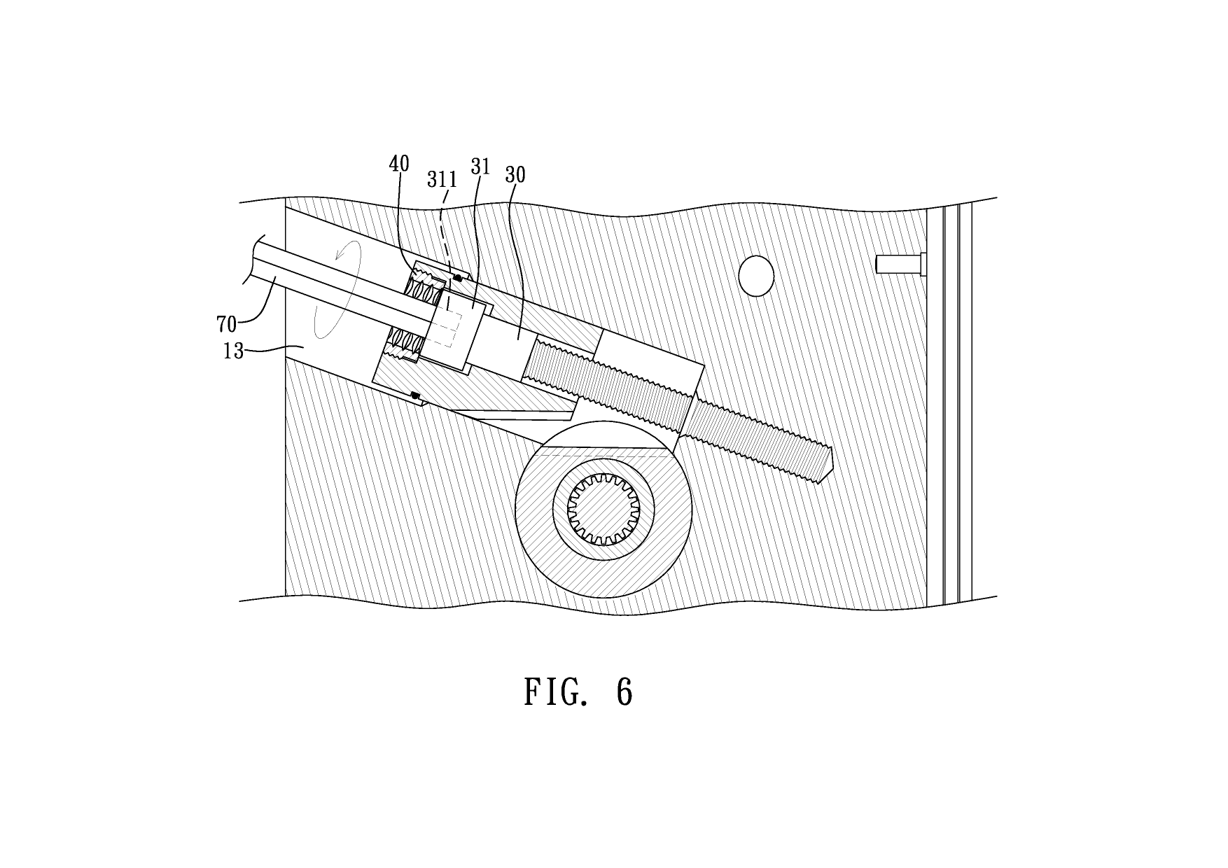

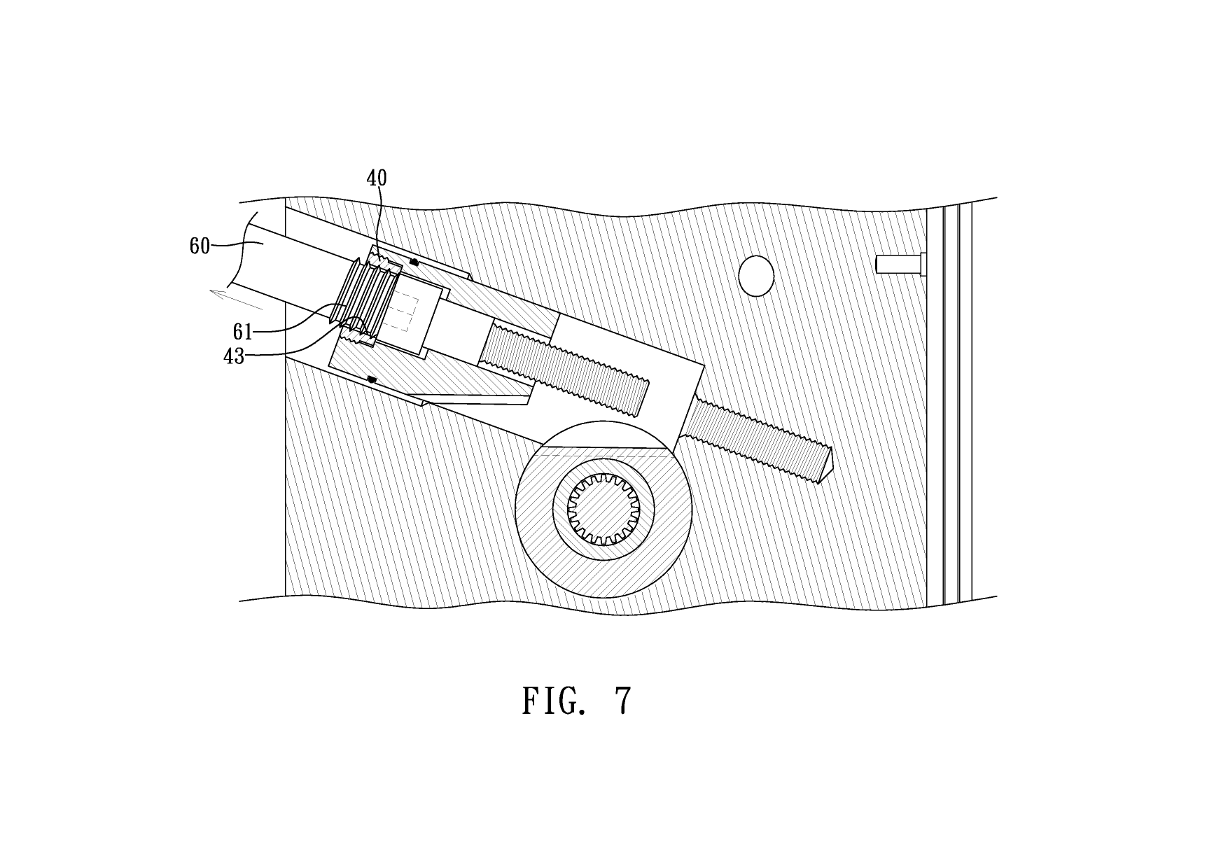

With reference to FIGS. 4-7, a conventional rotary tool turret (10) has multiple tool seats (11) mounted thereon, wherein the tool seats (11) are provided for mounting different tools (not shown). The rotary tool turret (10) includes multiple first holes (12) therein, wherein each tool seat (11) is partially received in a corresponding one of the first holes (12), and multiple second holes (13) defined in the rotary tool turret (10) wherein each second hole (13) communicates with a corresponding one of the first holes (12). Each tool seat (11) is formed with an engage portion (111) facing the corresponding second hole (13). Each second hole (13) has an engage device mounted therein for securely positioning the tool seat (11). As usual, the second hole (13) has a depth much greater than a total length of the engage device.

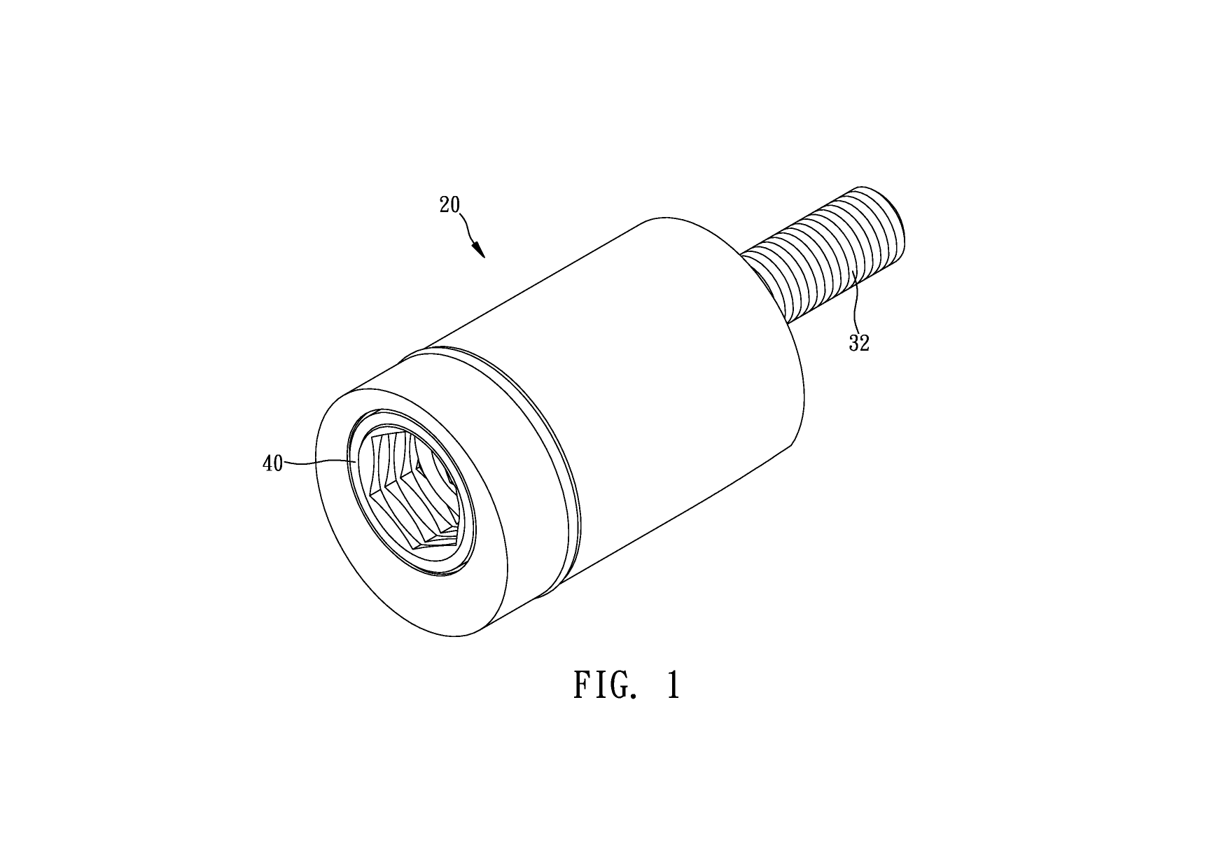

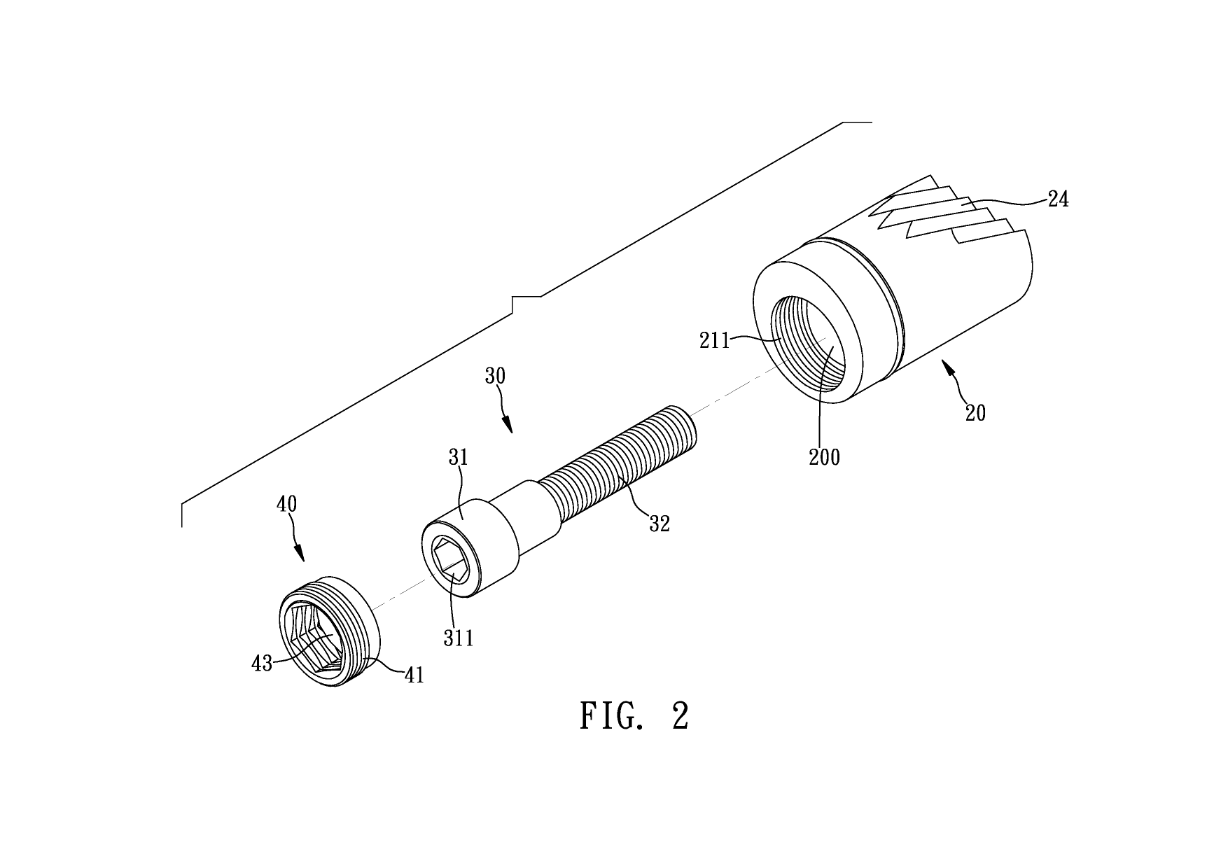

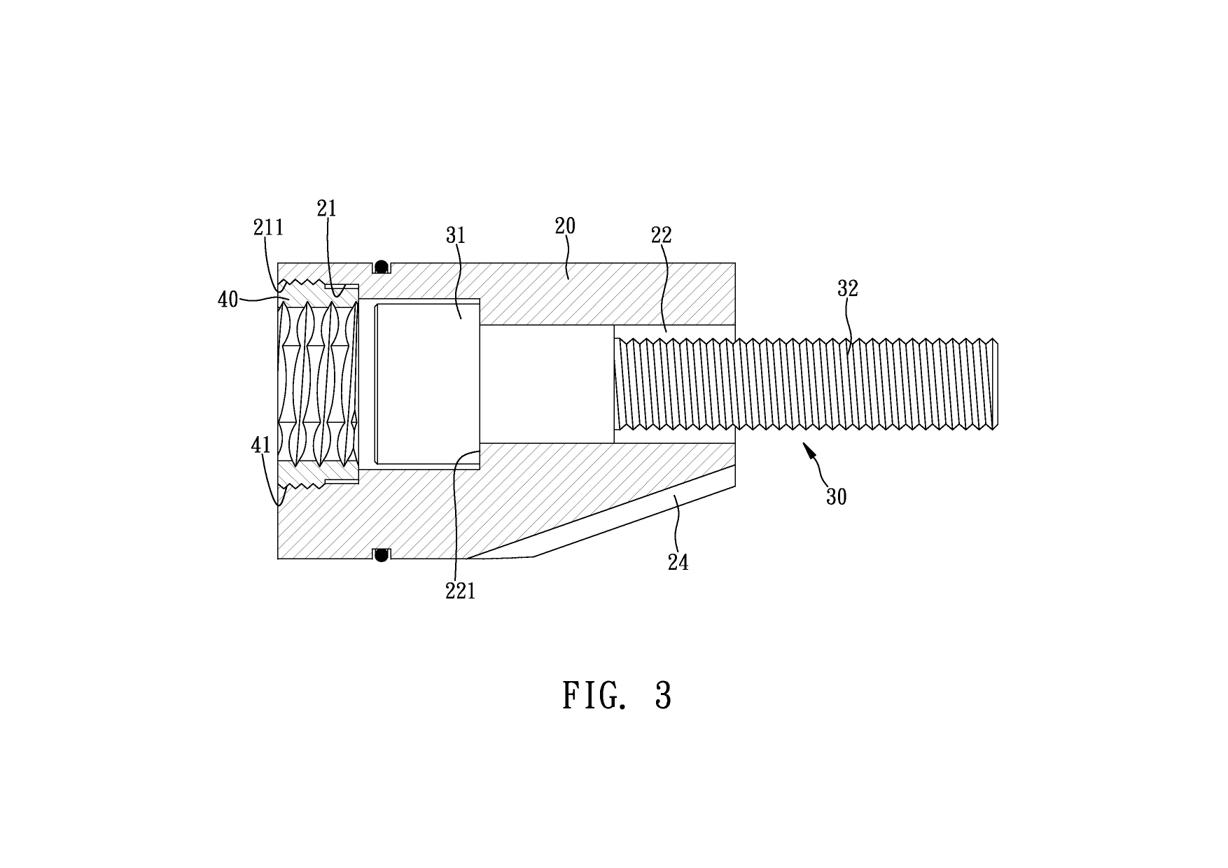

With reference to FIGS. 1-7, the engage device in accordance with the present invention includes an engage block (20) mounted into the corresponding second hole (13), a bolt (30) extending through the engage block (20) and a locking member (40) mounted to the engage block (20) to prevent the bolt (30) from detaching from the engage block (20).

The engage block (20) includes a through hole (200) eccentrically defined therein. The through hole (200) is divided into a first section (21) and a second section (22), wherein the first section (21) has a diameter grater than that of the second section (22) such that a shoulder (221) is formed between the first section (21) and the second section (22). The first section (21) has a threaded portion (211) formed on an inner periphery thereof near an opening of the through hole (200). An inclined engage portion (24) is formed on an outer periphery of the engage block (20) and corresponds to the second section (22) of the through hole (200).

The bolt (30) has a head (31) and a threaded rod (32) centrally and longitudinally extending from the head (31), wherein the head (31) abuts against the shoulder (221) and the threaded rod (32) extending through the second section (22) of the through hole (200). As a result, the bolt (30) is rotatable relative to the engage block (20). The head (31) has a polygonal hole (311) centrally and longitudinally defined therein.

The locking member (40) is formed with a threaded outer periphery (41) that is screwed onto the threaded portion (211) of the first section (21). The locking member (40) has a threaded polygonal hole (43) defined therein and extending therethrough, wherein the distance between two opposite sides of the polygonal hole (43) in the locking member (40) is greater than a length of a diagonal of the polygonal hole (311) in the head (31) of the bolt (30).

When mounting the engage device to the rotary tool turret (10) to secure the tool seat (11), the engage block (20) with the bolt (30) and the locking member (40) is put into the second hole (13) and make the engage portion (24) of the engage block (20) corresponding to that of the tool seat (11). A wrench (70) extends through the threaded polygonal hole (43) and into the polygonal hole (311) such that the engage block (20) is gradually moved toward a bottom of the second hole (13) to make the two engage portions (111, 24) securely abutting each other for holding the tool seat (11) in place when the bolt (30) is rotated relative to the engage block (20) and threaded rod (32) is screwed into the threaded hole (131) in the rotary tool turret (10).

When the replacing the tool seat (11), the operator only needs to lose the bolt (30) to make the engage portion (24) of the engage block (20) away from the engage portion (111) of the tool seat (11). Then, the operator can easily detach tool seat (11) from the rotary tool turret (10).

When disassembling the engage device in accordance with the present invention, the wrench (70) passes through the threaded polygonal hole (43) in the locking member (40) and is engaged into the polygonal hole (311) in the blot (30). The operator can loose the bolt (30) by rotating the wrench (70) to make the threaded rod (32) of the bolt (30) completely separated from the threaded hole (131) in the rotary tool turret (10). Finally, an elongate tool (60), including a threaded rod (61) longitudinally extending therefrom, is inserted into the second hole (13) and the threaded rod (61) is screwed into the threaded polygonal hole (43). Then, the operator can pull the engage block (20) with the bolt (30) and the locking member (40) by the elongate tool (60) that is longitudinally connected to the locking member (40).

Although the invention has been explained in relation to its preferred embodiment, it is to be understood that many other possible modifications and variations can be made without departing from the spirit and scope of the invention as hereinafter claimed.

What is claimed is:

1. An engaged device for positioning a tool seat of a rotary tool turret, comprising:
an engage block adapted to be mounted into the rotary tool turret, the engage block including a through hole eccentrically defined therein, the through hole divided into a first section and a second section, wherein the first section has a diameter grater than that of the second section such that a shoulder is formed between the first section and the second section, an inclined engage portion formed on an outer periphery of the engage block and corresponds to the second section of the through hole, wherein the inclined engage portion is adapted to securely abut and position the tool seat when the engage block is positioned in the rotary tool turret;
a bolt extending through the engage block, the bolt having a head and a threaded rod centrally and longitudinally extending from the head, wherein the head abuts against the shoulder and the threaded rod extending through the second section of the through hole such that the bolt is rotatable relative to the engage block and the threaded rod is adapted to be screwed into the rotary tool turret, the head having a polygonal hole centrally and longitudinally defined therein; and
a bolt mounted into the first section of the through hole in the engage block to prevent the bolt from detaching from the engage block, the locking member having a threaded polygonal hole defined therein and extending therethrough, wherein the distance between two opposite sides of the polygonal hole in the locking member is greater than a length of a diagonal of the polygonal hole in the head of the bolt.

2. The engage device as claimed in claim 1, wherein the first section of the through hole in the engage block having a threaded portion formed on an inner periphery thereof near an opening of the through hole.

3. The engage device as claimed in claim 2, wherein locking member is formed with a threaded outer periphery that is screwed onto the threaded portion of the first section of the through hole in the engage block.
